(19) United States
(12) Patent Application Publication
(10) Pub. No.: US 2009/0103867 A1
(43) Pub. Date: Apr. 23, 2009

(54) Variable Optical Attenuator

(75) Inventors: Qing Huang, Shenzhen (CN); Chang Xiao, Shenzhen (CN); Xiaolin Chen, Shenzhen (CN); Yatao Yang, Plano, TX (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 12/245,817

(22) Filed: Oct. 6, 2008

Related U.S. Application Data
(60) Provisional application No. 60/981,647, filed on Oct. 22, 2007.

(51) Int. Cl. G02B 6/26

(52) U.S. Cl. 385/48

(57) ABSTRACT

A compact variable optical attenuator having optical-tap functionality is described comprising a planar waveguide attenuator, a lens, and a photodetector. Input and output waveguides are located close to the optical axis of the lens, which reduces optical aberrations and insertion loss. The waveguide attenuator works by light absorption with virtually no scattered light present, which improves fidelity of measurements of the tapped optical power by the photodetector. The entire tap-attenuator assembly is packaged into a small form pluggable (SFP) package having two optical connectors.

### CROSS-REFERENCE TO RELATED APPLICATIONS

The present invention claims priority from 60/981,647, filed Oct. 22, 2007, which is incorporated herein by reference.

### TECHNICAL FIELD

The present invention is related to optical devices for attenuating light and, in particular, to compact variable optical attenuators having an additional function of measuring optical power of light.

### BACKGROUND OF THE INVENTION

In optical communication networks, light signals are modulated with a binary stream of data and transmitted through optical fibers spanning from one location to another. On their way from a source to a destination, the light signals can be amplified, multiplexed, routed, and passed between various fiber spans. All these operations reduce optical power of the signals, with the exception of amplification, which boosts the power back to an acceptable level. Overall, the optical power of the signals is maintained within a certain range, in order for a signal to be properly amplified and ultimately detected at a destination point.

In order to measure the optical power of a signal propagating in an optical fiber, optical taps are implemented which split off a small portion of a signal passing through an optical fiber, and couple this portion to a photodetector, which produces a photocurrent representative of the total optical power of the signal carried by the optical fiber. In order for an optical tap to work reliably, it is important that the fraction of the optical power coupled to the photodetector remains constant. This is not an easy requirement because optical taps usually use a small fraction of the total power, for example 5%, to make a measurement representative of total optical power. For an optical tap to measure the total optical power with an accuracy of, for example, 1%, the fraction of the optical power of the split signal has to remain constant to within 5%×1%=0.05% of the total power of the propagating optical signal, over a wide range of temperatures and values of humidity, during the entire lifetime of the device. In addition, it is quite common that many optical taps are employed in a single optical network system; therefore it is also important that the taps be compact and inexpensive.

When optical power measured by an optical tap is found to be outside of a range imposed by the system requirements, the power needs to be adjusted. There are generally two approaches to adjusting the optical power of an optical signal. The first approach is to change an amplification setting of an optical amplifier, for example, by adjusting the drive current of a pump laser diode, and the second approach is to adjust attenuation of an optical signal by adjusting a setting of a component called a variable optical attenuator, or VOA. The second approach is much cheaper to realize in practice because VOA is a passive component only containing a few elements, and an optical amplifier is typically a rather complex module containing many passive and active components such as active and passive specialty fibers, pump laser diodes, multiplexors, isolators, and other components. Not only that, but, quite frequently, a VOA is one of those components, and the adjustment of an operating point of such an optical amplifier includes adjustments of both the pump current and the VOA setting.

Since adjustments of optical power of a signal in an optical communications network usually involve measurements of the optical power before and, or after the adjustment point, it is advantageous to combine both functions in a single device. The most straightforward way of combining an optical tap and a VOA is to splice an output fiber of the VOA to an input fiber of the optical tap, or vice versa. Referring to FIG. 1A, a prior art VOA—optical tap device 100 is shown comprising a waveguide attenuator 103, an optical tap, not shown, integrated into a package 104, a connecting fiber 106, an input fiber 108, and an output fiber 110. The waveguide attenuator 103 has a planar waveguide 112, which absorbs the light passing therethrough in dependence upon a concentration of free carriers injected into a light-carrying region of the waveguide 112. A photodetector, not shown, has contacts 114 for outputting an electrical signal representing the tapped optical power.

The disadvantage of the approach based on splicing a VOA and an optical tap is that the resulting device is not very compact. Indeed, in order to perform a fiber splice, a length of an optical fiber of at least a few centimeters is required on both ends of the splice; after splicing, this fiber would have to be coiled inside the package. It should be noted that coiling of an optical fiber is different from, for example, coiling of an electrical wire in that the bending radius of an optical fiber has to remain larger than a certain minimal bending radius, because too tightly wound optical fiber can loose its optical guiding property and, or merely break. A minimal bending radius of a few centimeters has to be observed for most fibers presently used in fiberoptic communication systems.

Accordingly, referring now to FIG. 1B, another view of the device 100 is presented, in which the components inside the package 104 are shown comprising an optical tap 105, two fiber coils 106-1 and 106-2, and a fiber splice protector 107. As mentioned above, in order to connect two fiber-coupled optical devices using a splice, a length of fiber has to be provided on both ends of the splice. Upon splicing the waveguide attenuator 103 and the optical tap 105, the fiber on both ends of splice protector 107 is coiled into fiber coils 106-1 and 106-2. As a result of having to accommodate fiber coils 106-1 and 106-2, the size of package 104 tends to be a few times larger than the size of optical tap 105 packaged, or integrated, into the package 104.

One solution to the abovementioned problem was suggested by He et al. in U.S. Pat. No. 7,346,240, which is incorporated herein by reference. He et al. describes a hybrid VOA—optical tap device, in which a small mechanical shutter is electromagnetically actuated to attenuate light.

Turning now to FIG. 2, a cross section of a VOA part 420 of a prior art VOA—optical tap hybrid device of He et al. is shown comprising an input and an output fiber 101 and 102, respectively, a dual fiber pigtail, or ferrule 421, a wire 422, a shutter 423, a gradient index (GRIN) lens 424 having an angled end facet 426 and an opposing straight facet coated with a high reflector (HR) coating 427, a magnetic lens holder 425, and a magnet 430. The function of GRIN lens 424 is twofold. First, the lens 424 collimates an input optical beam, emitted by input fiber 101, and second, it focuses an output optical beam, that is the beam reflected from HR coating 427, onto the output fiber 102. The function of the HR coating 427 on the GRIN lens 424 is to split a small fraction of the incoming light for coupling to a photodetector, not shown. In operation, an electric current is passed through the wire 422 which causes the shutter 423 to turn and partially shield the input and output light beams. The more the light beams are shielded by the shutter 423, the more the VOA 420 attenuates light.

Placing the movable shutter 423 near the tips of the fibers 101 and 102 in a dual fiber pigtail, or the ferrule 421, has a number of serious drawbacks. Specifically, one drawback is that placing an object near a fiber tip creates a possibility of backreflection into that fiber. Even when the shutter 423 is blackened, still a significantly large fraction of light scattered by the shutter 423 can enter the fiber 101. As has been noted above, a VOA is often used inside an optical amplifier. Because fiber amplifiers can provide an amplification of 40 dB and higher, even a small backreflection of about −40 dB can create feedback in an EDFA which would render the EDFA inoperable, or at least it would introduce noise. Further, disadvantageously, a fraction of the scattered light can pass through the GRIN lens 424 and the coating 427 and reach a photodetector, not shown, which will modify a fraction of the incoming signal seen by the photodetector. Since the fraction of the optical power of light at a photodetector is small, for example it can be 1%-5% of the optical power of incoming light, even a minute amount of scattered light reaching the photodetector, for example 0.5% of the optical power of incoming light, would result in an error in measurement of the optical power of light passing through the VOA 420. For example, for the 1% tap, the error is 50%, and for 5% tap, the error is 10%.

Further, disadvantageously, when the shutter 423 is used to attenuate both free-space propagating beams associated with the fibers 101 and 102, another potential source of error in the measurement of optical power exists due to the following. The shutter 423 is positioned between the tips of the fibers 101 and 102. When the position of the shutter 423 changes even slightly, for example, due to shock, vibration, or simply fatigue of the wire 422 on which the shutter 423 is suspended, the ratio of attenuation due to shielding the incoming beam emitted by the tip of the fiber 101, to the attenuation due to shielding the reflected beam impinging on the tip of the fiber 102, will change, which will effectively change the fraction of the optical power seen by the photodetector, not shown.

The disadvantages of the approach illustrated in FIGS. 1A, 1B, and FIG. 2 are overcome by the present invention. The goal of the present invention is to provide a VOA-tap hybrid device having high fidelity of optical power measurement, high reliability, low backreflection, and compact size. Preferably, the size of the device has to be compact enough so that a standard small form pluggable (SFP) package can be used as a housing of the device.

### SUMMARY OF THE INVENTION

In accordance with the invention there is provided a variable optical attenuator comprising:
an input optical port and an output optical port;
a planar waveguide attenuator for attenuating light in dependence upon a control signal applied thereto, wherein the planar waveguide attenuator has first and second ends, wherein the first end of the planar waveguide attenuator is optically coupled to the input optical port, and the second end of the planar waveguide attenuator is disposed to produce a divergent optical beam;
a lens for collimating said divergent optical beam into a collimated optical beam;
a beamsplitter optically coupled to the lens for splitting the collimated optical beam into a reflected optical beam and a transmitted optical beam;
a photodetector disposed to receive the transmitted optical beam, for producing an electric signal in dependence upon the power of said transmitted optical beam; and
an output waveguide for guiding the reflected optical beam to the output port;
wherein in operation, the reflected optical beam is focused by the lens into the output waveguide.

In accordance with another aspect of the invention there is further provided a variable optical attenuator comprising:
first and second optical ports each disposed for receiving and outputting light;
a planar waveguide attenuator for attenuating the light in dependence upon a control signal applied thereto, wherein the planar waveguide attenuator has first and second ends, wherein the first end of the waveguide attenuator is optically coupled to the first optical port;
a connecting waveguide having first and second ends, wherein the first end of the connecting waveguide is optically coupled to the second optical port;
a lens for providing optical coupling between the second end of the planar waveguide attenuator and the second end of the connecting waveguide;
a tap optically coupled to the lens for measuring the optical power of a light passing therethrough, wherein the tap includes:
   a beamsplitter for splitting off a fraction of a light incident thereon, and
   a photodetector for receiving said fraction and producing an electric signal in dependence upon the optical power thereof.

### BRIEF DESCRIPTION OF THE DRAWINGS

Exemplary embodiments will now be described in conjunction with the drawings in which:

FIG. 1A is a prior art variable optical attenuator (VOA)—optical tap combination obtained by splicing a VOA to an optical tap;

FIG. 1B is a detailed view of optical fiber coiling in the prior art VOA—optical tap combination obtained by splicing a VOA to an optical tap;

FIG. 2 is a cross-sectional view of a core section of a prior art VOA—optical tap hybrid device;

FIG. 3A is a plan view of one preferred embodiment of the VOA—optical tap device of the present invention;

FIG. 3B is a side view of the VOA—optical tap device of FIG. 3A;

FIG. 4A is a plan view of another preferred embodiment of the VOA—optical tap device of the present invention;

FIG. 4B is a side view of the VOA—optical tap device of FIG. 4A;

FIG. 5 is a plan view of yet another preferred embodiment of the VOA—optical tap device of the present invention;

FIG. 6 is a plan view of the VOA—optical tap device of FIGS. 3A and 3B packaged into a standard small form pluggable (SFP) package;

FIG. 7 is an isometric view of the VOA—optical tap device of the present invention packaged into the SFP package.

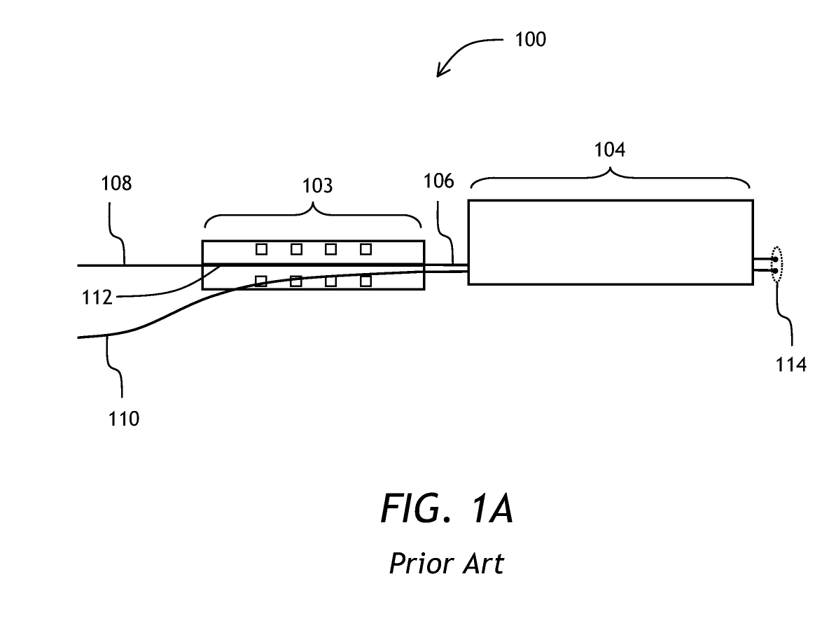

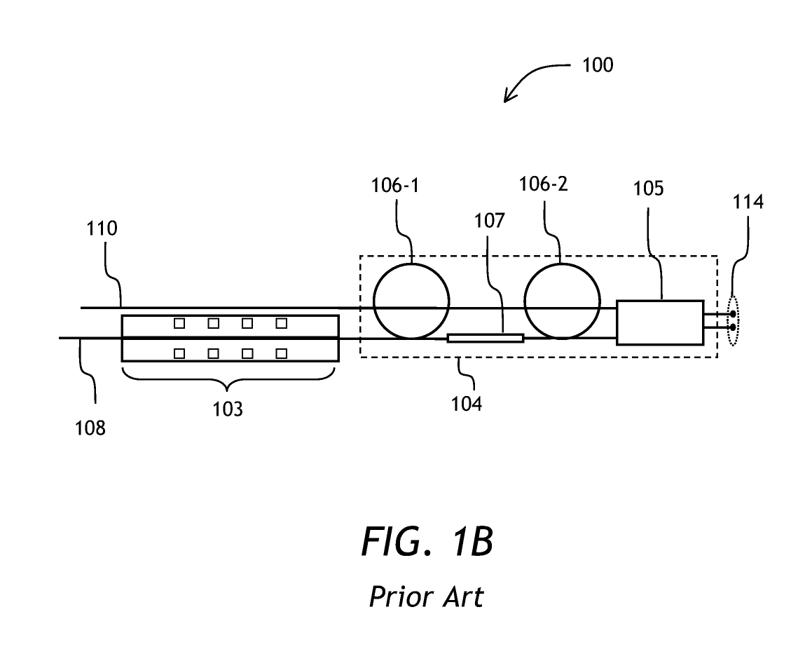

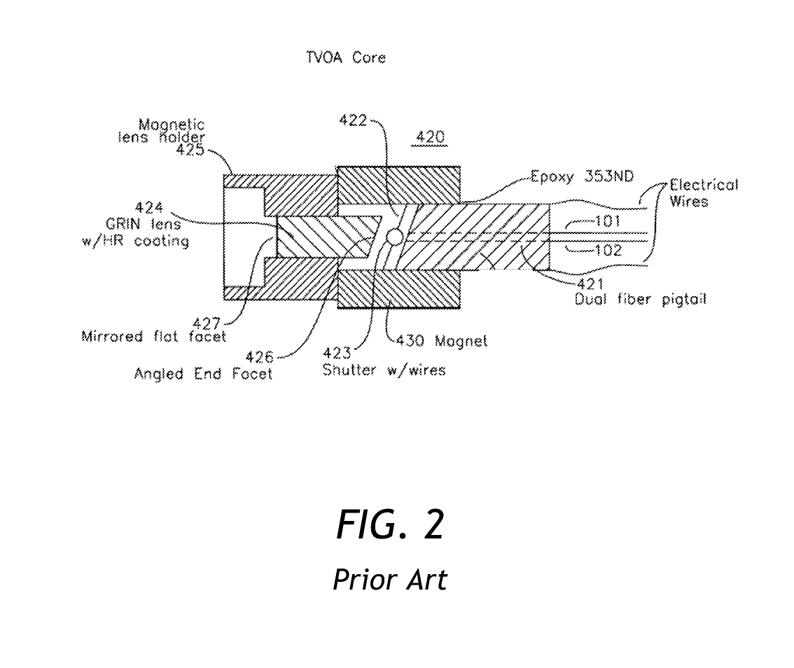

### DETAILED DESCRIPTION OF THE INVENTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Like numbers refer to like elements throughout.

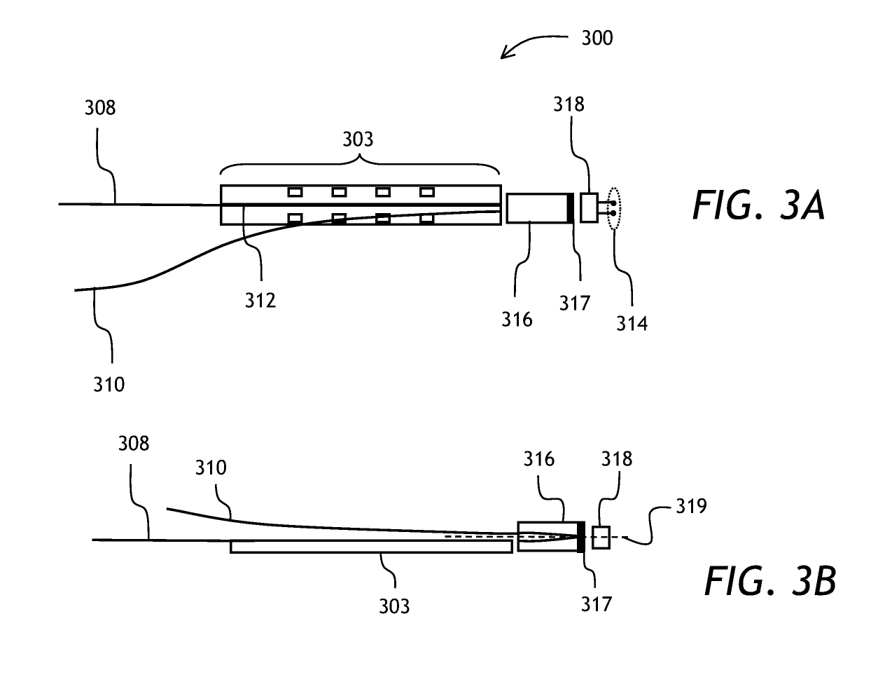

Referring now to FIG. 3A, a plan view of one preferred embodiment of the VOA—optical tap device 300 of the instant invention is shown comprising a waveguide optical attenuator 303 having a planar waveguide 312, a GRIN lens 316 having a beamsplitter coating 317, and a photodetector 318 having electrical contacts 314. The waveguide optical attenuator 303 attenuates light by a mechanism of free carrier absorption, wherein the free carriers are injected into a region of the waveguide 312 by supplying an electrical current to the waveguide 303. An input optical fiber 308 is butt-coupled to the planar waveguide 312, and an output optical fiber 310 is brought into close proximity to the GRIN lens 316. In FIG. 3B, the disposition of the output optical fiber 310 is shown in more detail. The output optical fiber 310 is positioned on the waveguide attenuator 303, in close proximity to the planar waveguide 312. In operation, a guided light beam coupled into the planar waveguide 312 from the input fiber 308 propagates along the planar waveguide 312 and is attenuated according to the amount of the electrical current applied to the waveguide attenuator 303. Upon reaching the right end of the waveguide attenuator 303, the light beam is emitted into a free space and collimated by lens 316. The collimated beam reflects from the beamsplitter coating 317 and propagates back through the lens 316, which focuses the beam onto the tip of the output optical fiber 310. Optical axis 319 of the lens 316 is disposed slightly above the upper surface of the waveguide attenuator 303 as is seen in FIG. 3B, whereby the beam of light is directed out of the plane of the waveguide 312 and is incident on the beamsplitter coating 317 at a small angle of incidence, e.g. 0.1 to 5 degrees. Accordingly, the collimated beam is reflected at an angle of reflection, which is the same as the angle of incidence, and the focused beam is coupled into output fiber 310.

The VOA—optical tap device 300 of FIGS. 3A and 3B has a number of advantages, which are the advantages of a VOA without any optical tap implemented on the base of the waveguide VOA element 303. These advantages are as follows. First, the device 300 of FIGS. 3A and 3B does not have any moving parts, which makes it insensitive to shock and vibration. Second, the device 300 does not employ any magnets and therefore can be made very compact due to the compact size of the waveguide attenuator component 303. Third, the optical backreflection of the device 300 is low.

The other advantages of device 300 are not the advantages of a waveguide VOA itself, but rather these advantages are unexpectedly brought forward when an optical tap is implemented therewith, as is shown in FIGS. 3A and 3B. Namely, the VOA 303 works by free carrier light absorption, which means that there is no scattered light present, which can reach photodetector 318 and render the optical power measurements unreliable. Further, advantageously, the planar waveguide 312 and the output fiber 310 can be placed in close proximity to each other and to the optical axis 319, which conveniently reduces the effect of the optical aberrations of the lens 316 and improves overall insertion loss of device 300.

Not only that, but, advantageously, both the input fiber 308 and the output fiber 310 are disposed on the same side of the device 300, which simplifies the integration of device 300 into an optical network system, since no fiber coiling or bending is required.

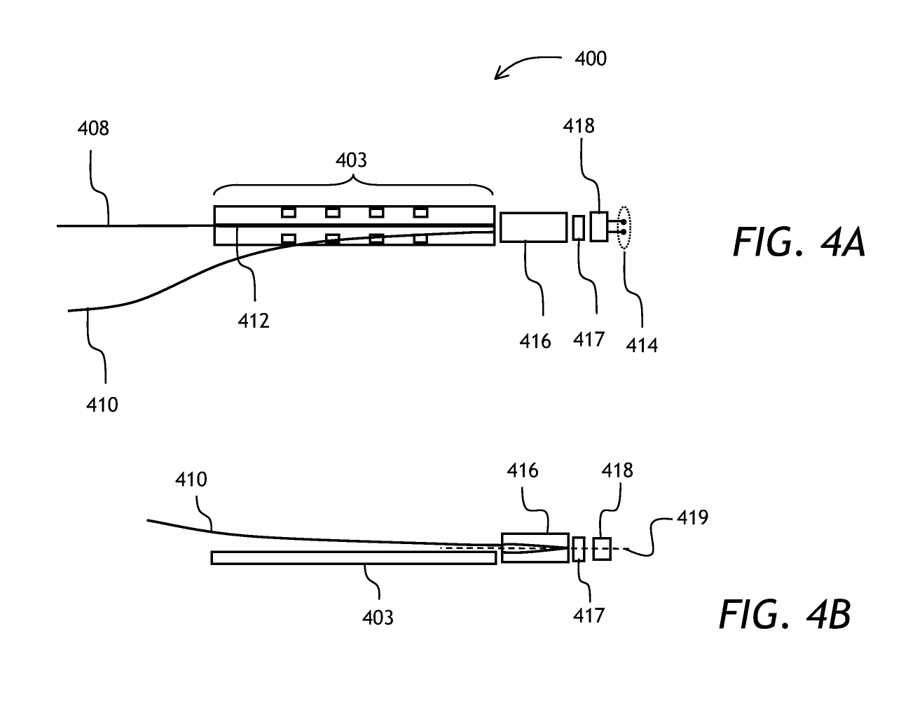

Referring now to FIG. 4A, a plan view of another preferred embodiment of a VOA—optical tap device 400 of the present invention is shown comprising a waveguide optical attenuator 403 having a planar waveguide 412, a lens 416, and a photodetector 418 having electrical contacts 414. What differentiates device 400 from the device 300 of FIG. 3A is the presence of a separate beamsplitter element 417 located behind lens 416. Preferably, the beamsplitter element 417, or the beamsplitter coating 317 of FIG. 3A and 3B, has a reflection coefficient in the range of 90 to 99%, the optimal value being close to 95%. The separate beamsplitter element 417 can be convenient when the lens 416 does not have flat surfaces, for example when the lens 416 is an aspheric lens produced by a molding process or by another suitable process. Aspheric lenses allow one to further reduce optical aberrations and further reduce the optical insertion loss.

In FIG. 4B, the disposition of the output fiber 410 is shown in more detail. It is analogous to disposition of the output fiber 310 of FIG. 3B. Again, placing tips of the waveguide 412 and the fiber 410 close to each other allows one to further reduce optical aberrations and improve optical insertion loss, since the incoming and outgoing beams are located closer to an optical axis 419 of the lens 416.

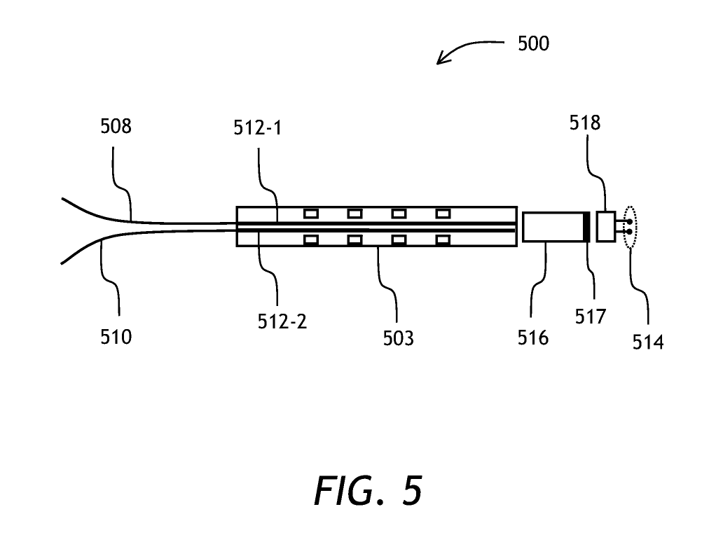

Turning now to FIG. 5, a plan view of yet another preferred embodiment of a VOA—optical tap device 500 of the present invention is shown comprising a waveguide optical attenuator 503 having two planar waveguides 512-1 and 512-2, a GRIN lens 516 having a beamsplitter coating 517, and a photodetector 518 having electrical contacts 514. The waveguide optical attenuator 503 attenuates light guided by the planar waveguide 512-1 by a mechanism of free carrier absorption, or by any other suitable mechanism. An input optical fiber 508 is butt-coupled to planar waveguide 512-1, and an output optical fiber 310 is butt-coupled to the planar waveguide 512-2. The advantage of the device 500 of FIG. 5, in addition to other advantages analogous to those of the devices 300 and 400 of FIGS. 3A and 4A, is that both the planar waveguides 512-1 and 512-2 are monolithically integrated into the waveguide attenuator 503, which simplifies the optomechanical assembly of the device 500.

In the VOA—optical tap devices of FIGS. 3A, 3B, 4A, 4B, and FIG. 5, the input and output fibers can be switched, or in other words, fibers 310, 410 and 510 can be used as input fibers, and fibers 308, 408, and 508 can be used as output fibers. When the fibers are switched, the optical taps will measure the optical power before attenuation, not after attenuation. This may be advantageous for applications where the measured optical power value is used to not only set the attenuation value, but also, for example, to adjust a pump power in a fiber amplifier.

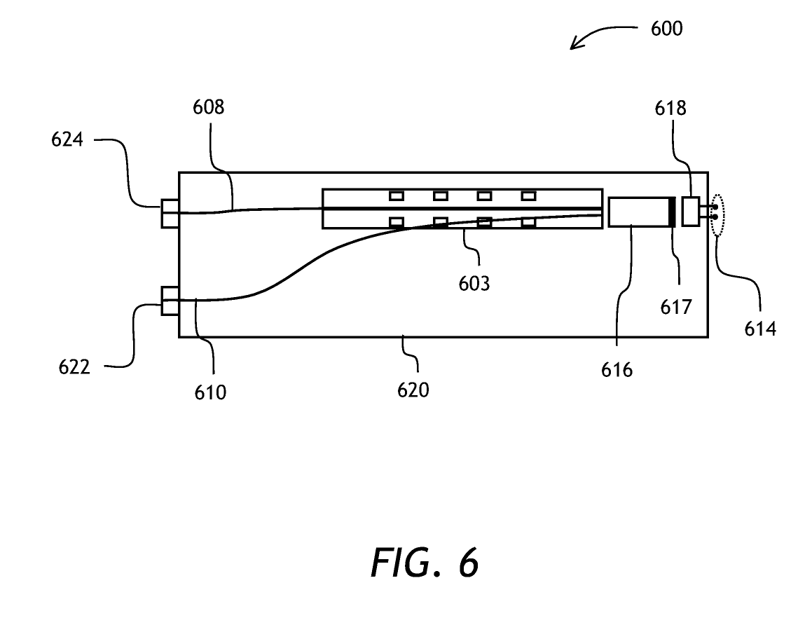

Turning now to FIG. 6, a plan view of a VOA—optical tap device 600 of the instant invention is shown comprising a waveguide optical attenuator 603, a GRIN lens 616 having a beamsplitter coating 617, a photodetector 618, two optical fibers 608 and 610, and a standard small form pluggable (SFP) package 620, which the elements 603, 608, 610, 616, and 618 are packaged into. Fiberoptic connectors 622 and 624 are conveniently located on the outside of the SFP package 620 for connecting external optical fibers. The optical fibers 608 and 610 connecting waveguide 603 and GRIN lens 616 to the fiberoptic connectors 624 and 622, respectively, are slightly bent in order to eliminate tensile stress inside the package 620. A pair of electrical terminals 614 is used for connecting the photodetector 618 to an electrical amplifier.

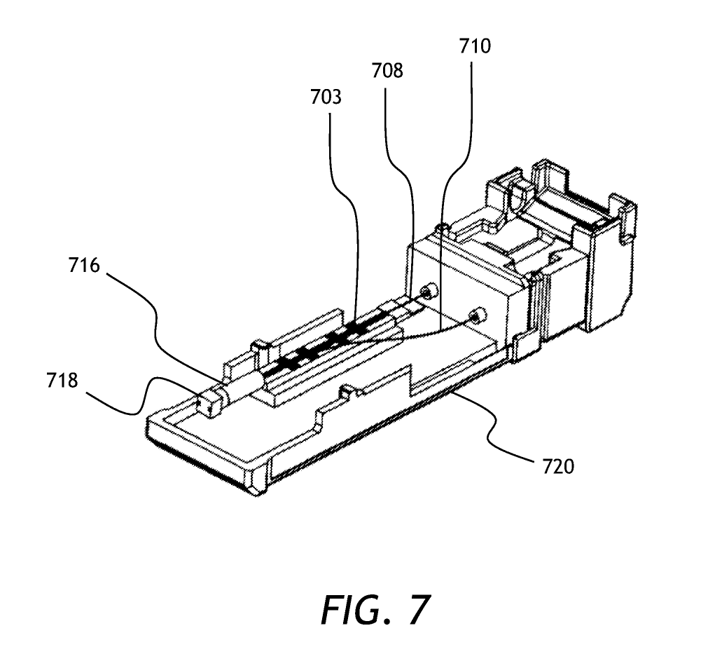

Referring now to FIG. 7, an isometric view of the device 600 of FIG. 6 is presented comprising a waveguide attenuator 703, input and output fibers 708 and 710, a GRIN lens 716, a photodetector 718, and a SFP package 720 measuring approximately 55×12×10 mm.

What is claimed is:

1. A variable optical attenuator comprising:
an input optical port and an output optical port;
a planar waveguide attenuator for attenuating light in dependence upon a control signal applied thereto, wherein the planar waveguide attenuator has first and second ends, wherein the first end of the planar waveguide attenuator is optically coupled to the input optical port, and the second end of the planar waveguide attenuator is disposed to produce a divergent optical beam;
a lens for collimating said divergent optical beam into a collimated optical beam;
a beamsplitter optically coupled to the lens for splitting the collimated optical beam into a reflected optical beam and a transmitted optical beam;
a photodetector disposed to receive the transmitted optical beam, for producing an electric signal in dependence upon the power of said transmitted optical beam; and
an output waveguide for guiding the reflected optical beam to the output port;
wherein in operation, the reflected optical beam is focused by the lens into the output waveguide.

2. A variable optical attenuator of claim 1, wherein the output waveguide is an optical fiber, and wherein the lens has an optical axis parallel to a plane containing the first and the second ends of the planar waveguide attenuator, wherein said axis is shifted from said plane such that the angle of incidence of the collimated optical beam on the beamsplitter is between 0.1 and 5 degrees.

3. A variable optical attenuator of claim 1, wherein the output waveguide is a planar waveguide formed in the planar waveguide attenuator.

4. A variable optical attenuator of claim 1, wherein the lens is a GRIN lens having first and second ends, wherein the first end of the GRIN lens is coupled to the second end of the planar waveguide attenuator, and wherein the beamsplitter is a thin film coating applied to the second end of the GRIN lens.

5. A variable optical attenuator of claim 1, wherein the planar waveguide attenuator has a structure for absorbing the light due to the phenomenon of a free-carrier absorption.

6. A variable optical attenuator of claim 1, wherein the beamsplitter has a reflectivity of between 90% and 99%.

7. A variable optical attenuator of claim 1, wherein the beamsplitter has a reflectivity of 95%±1%.

8. A variable optical attenuator of claim 1, further comprising a small form pluggable (SFP) package for supporting the planar waveguide attenuator, the lens, the photodetector, the input optical port, and the output optical port.

9. A variable optical attenuator comprising:
first and second optical ports each disposed for receiving and outputting light;
a planar waveguide attenuator for attenuating the light in dependence upon a control signal applied thereto, wherein the planar waveguide attenuator has first and second ends, wherein the first end of the planar waveguide attenuator is optically coupled to the first optical port;
a connecting waveguide having first and second ends, wherein the first end of the connecting waveguide is optically coupled to the second optical port;
a lens for providing optical coupling between the second end of the planar waveguide attenuator and the second end of the connecting waveguide;
a tap optically coupled to the lens for measuring the optical power of a light passing therethrough, wherein the tap includes:
a beamsplitter for splitting off a fraction of a light incident thereon, and
a photodetector for receiving said fraction and producing an electric signal in dependence upon the optical power thereof.

10. A variable optical attenuator of claim 9 wherein the connecting waveguide is an optical fiber, and wherein the lens has an optical axis parallel to a plane containing the first and the second ends of the planar waveguide attenuator, wherein said axis is shifted from said plane such that the angle of incidence of the collimated optical beam on the beamsplitter is between 0.1 and 5 degrees.

11. A variable optical attenuator of claim 9 wherein the connecting waveguide is a planar waveguide formed in the planar waveguide attenuator.

12. A variable optical attenuator of claim 9, wherein the first optical port is an input optical port, and the second optical port is an output optical port.

13. A variable optical attenuator of claim 9, wherein the first optical port is an output optical port, and the second optical port is an input optical port.

14. A variable optical attenuator of claim 9 wherein the lens is a GRIN lens having first and second ends, wherein the first end of the GRIN lens is coupled to the second end of the planar waveguide attenuator, and wherein the beamsplitter is a thin film coating applied to the second end of the GRIN lens.

15. A variable optical attenuator of claim 9 wherein the planar waveguide attenuator has a structure for absorbing the light due to the phenomenon of a free-carrier absorption.

16. A variable optical attenuator of claim 9 wherein the beamsplitter has a reflectivity of between 90% and 99%.

17. A variable optical attenuator of claim 9 wherein the beamsplitter has a reflectivity of 95%±1%.

18. A variable optical attenuator of claim 9, further comprising a small form pluggable (SFP) package for supporting the planar waveguide attenuator, the lens, the photodetector, the connecting waveguide, the first optical port, and the second optical port.

19. A variable optical attenuator of claim 18 wherein the SFP package comprises first and second fiberoptic connectors optically coupled to the first optical port and to the second optical port, respectively, and first and second electrical terminals coupled to the photodetector, for outputting the electrical signal.

20. A variable optical attenuator of claim 18 wherein the SFP package measures approximately 55±2 mm×12±2 mm×10±2 mm.
